(19) United States
(12) Patent Application Publication
(10) Pub. No.: US 2011/0006447 A1
(43) Pub. Date: Jan. 13, 2011

(54) Method for Producing Hybrid Optical Element Grouping

(76) Inventor: Akiko Hara, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/867,038

(22) PCT Filed: Feb. 4, 2009
(86) PCT No.: PCT/JP2009/051865

§ 371 Date: Aug. 10, 2010

(30) Foreign Application Priority Data
Feb. 13, 2008 (JP) 2008-031568

(51) Int. Cl. G02B 1/12

(52) U.S. Cl. 264/1.36

(57) ABSTRACT

A method for producing a hybrid optical element grouping, wherein a molding die excellent in durability and mold releasing property is used to produce high quality plastic lenses having no strain. This method for producing a hybrid optical element grouping is a method for producing a hybrid optical element grouping comprising a flat glass plate and, disposed thereon, plural optical members formed from an actinic radiation curable resin. The method is characterized by applying the actinic radiation curable resin to a plastic molding die having plural cavities having shapes corresponding to the optical members to fill the cavities with the resin, disposing the flat glass plate on the resin, and irradiating the resin with light from at least one of the molding die side and the flat-glass-plate side to cure the actinic radiation curable resin packed in the molding die.

### TECHNICAL FIELD

The present invention relates to a method for producing a hybrid optical element grouping.

### BACKGROUND

Conventionally, from the viewpoint of excellent optical characteristics and mechanical strength, inorganic glass materials have been commonly used as constituent materials of optical elements (mainly lenses). However, with the advancement of miniaturization of devices employing optical elements, such optical elements need to be miniaturized. Therefore, in view of processability, in cases in which inorganic glass materials are used, it has become difficult to produce those having large curvature (R) or complex shape.

Thereby, plastic materials which are easily processed have been studied and then employed. As such plastic materials which are easily processed, thermoplastic resins featuring excellent transparency such as, for example, polyolefin, polymethyl methacrylate, polycarbonate, or polystyrene are cited. And in general, via injection molding thereof using a metallic mold, optical elements are produced.

On the other hand, in cases in which IC (Integrated Circuits) chips and other electronic components are mounted on a circuit board, via a technology in which metallic paste (for example, solder paste) is previously coated (subjected to potting) on a predetermined position of the circuit board and in the state where the electronic components are placed on the position, the circuit board is subjected to reflow treatment (heating treatment) to mount the electronic components on the circuit board, a technology has been developed to produce an electronic module at reduced cost (for example, Patent Document 1).

Over recent years, in the state where optical elements, in addition to electronic components, are further placed on a circuit board, soldering-reflow treatment as described above for an optical module integrated with the optical elements is carried out, whereby it has been desirable to further enhance production efficiency in a system to produce imaging devices (optical devices).

Of course, also in an optical module produced by a production system employing the above reflow treatment, it is desirable to more preferably use plastic optical elements producible at reduced cost than high-cost glass optical elements.

However, thermoplastic resins having been used as conventional optical element resin materials are softened and melted at relatively low temperatures, exhibiting thereby excellent processability. However, molded optical elements have the disadvantage of easy deformation by heat. When an electronic component incorporating an optical element is mounted on a board using a soldering-reflow process, the electronic element itself is also exposed to a heating ambience of about 260° C. Therefore, an optical element made of a thermoplastic resin exhibiting low heat resistance is degraded in shape, which is problematic.

Therefore, the present inventors conducted investigations on applications of thermally curable resins and actinic radiation curable resins as optical element plastic materials used for imaging devices (optical devices) produced using a reflow process. Such thermally curable resins and actinic radiation curable resins are liquid or exhibit fluidity before being cured, and exhibit excellent processability similarly to thermoplastic resins. Further, the thermally curable resins and actinic radiation curable resins do not exhibit such fluidity after being cured as shown in such thermoplastic resins, whereby also having characteristics of minimal deformation by heat.

However, in case in which production is conducted using a thermally curable resin via the same injection molding as in the conventional production method using a thermoplastic resin, since such a thermally curable resin usually exhibits lower viscosity than a thermoplastic resin, the thermally curable resin penetrates a space of the mold, and thereby liquid leakage or burrs may occur, or no resin is filled up, resulting in injection failure in some cases.

When an actinic radiation curable resin is used as an optical element plastic material, actinic radiation needs to be used during curing. Therefore, a conventional metallic mold exhibiting no optical transparency is unusable. Then, it is conceivable to replace such a metallic mold having been conventionally used with a transparent material such as glass. However, when an optical element is formed via injection molding using a glass molding die, similarly to the case of use of a thermally curable resin, low viscosity is exhibited prior to curing, resulting in the problem of liquid leakage from the molding die or occurrence of burrs. Further, such problems are noted that curing contraction is induced during heating whereby shape variation occurs, or due to relatively large linear expansion coefficient, shape variation occurs by temperature changes.

On the other hand, a technology to obtain an optical element exhibiting high heat resistance is being investigated in which as an optical lens suitable for reflow treatment, a lens section (an optical member) made of a curable resin such as a thermally curable resin is placed on a flat glass plate (for example, Patent Document 2). Further, a plurality of optical members made of a curable resin are placed on a flat glass plate to form a so-called “hybrid optical element grouping.” Thereby, a plurality of lenses are simultaneously molded, and after molding, the flat glass plate section is cut, whereby optical elements can be produced more inexpensively. Still father, only part of such optical elements obtained from the hybrid optical element grouping are constituted of a resin, whereby the used amount of the resin can be reduced, resulting in inhibition of shape variation during heating or during temperature changes.

However, in the invention described in Patent Document 2, no specific molding method or production method is described. Further, the optical element disclosed in Patent Document 2 is constituted in such a manner that a lens section made of a silicone resin being thermally curable is provided on a flat glass plate. When production is actually conducted, uniform heating is entirely required, which has produced such problems that the molding apparatus becomes larger in size and the molding time becomes extended.

Patent document 1: Unexamined Japanese Patent Application Publication No. 2001-24320

Patent document 2: Japanese Patent Publication No. 3926380

### DISCLOSURE OF THE INVENTION

### Problems to be Solved by the Invention

In view of the above circumstances, the present inventors conducted investigations on a method for producing a hybrid optical element grouping using a flat glass plate and an actinic radiation curable resin. In this case, when a process to produce such a hybrid optical element grouping is assumed, the following is taken into account: (1) an actinic radiation curable resin is filled in a molding die; (2) a flat glass plate is pressed from above the molding die; (3) thereafter, actinic radiation is irradiated thereto to cure the thus-filled actinic radiation curable resin in the molding die; and (4) finally, mold releasing is carried out.

However, when a molding die is made of a metal, no radiation irradiation can be carried out from the molding die side, whereby the molding time needs to be extended, and additionally the cost of forming the mold is increased. When the molding die is made of glass, both the molding die and the flat glass plate are made of glass. Thereby, the molding die and the flat glass plate each exhibit poor flexibility, becoming whereby hard to be unreleasable when the flat surface portions of the both are brought into close contact in the step of above (2), resulting in the possibility of breakage of the fiat glass plate. Further, the molding die and the flat glass plate each exhibit no flexibility, whereby the flat glass plate is frequently arranged in the state of being inclined with respect to the molding die; when foreign substances are present therebetween, a space is formed between the flat glass plate and the molding die, whereby liquid leakage from the molding die frequently occurs in the pre-molding stage; and when high pressure is applied, the flat glass plate or the molding die is subjected to strain, resulting in the possibility of breakage occurrence. Still further, since the molding die is made of glass, due to its material, such handling problems as heavy weight and easy breakage are produced, and there is also noted a problem such that it is difficult to conduct processing/polishing treatment of cavity portions.

Therefore, a main object of the present invention is to provide a method for producing a hybrid optical element grouping in which the durability and releasing properties of a molding die during molding can be enhanced and further a high grade plastic lens exhibiting no distortion occurrence can be produced.

### Means to Solve the Problems

According to the present invention, in a method for producing a hybrid optical element grouping in which a plurality of actinic radiation curable resin optical members are arranged on a flat glass plate, provided is a method for producing a hybrid optical element grouping in which the actinic radiation curable resin is filled in a plastic molding die containing a plurality of cavities each having a shape corresponding to the optical members; thereon the flat glass plate is arranged; and radiation is irradiated from at least one direction of the molding die side and the flat glass plate side to cure the actinic radiation curable resin having been filled in the molding die.

Further, in the present invention, the transmittance of irradiation light for curing is preferably at least 90% in the thinnest portion of the molding die. In this case, radiation can be irradiated from both the flat glass plate side and the molding die side, whereby an actinic radiation curable resin filled in the molding die is easily cured, resulting in reduction of the molding time.

Still further, in the present invention, the molding die is preferably constituted of a thermoplastic resin, and further the thermoplastic resin is preferably an alicyclic hydrocarbon-based resin. When a molding die is constituted of such a thermoplastic resin, an injection molding technology, which has been conventionally employed, can be converted as such to easily produce the molding die. Further, when the thermoplastic resin is an alicyclic hydrocarbon-based resin, its extremely low hygroscopicity makes it possible that the life duration of the molding die is extended. Still further, the alicyclic hydrocarbon-based resin such as a cycloolefin resin exhibits excellent light stability and optical transparency. Therefore, even when light of short wavelength such as a UV radiation source is used to cure an actinic radiation curable resin, less deterioration results and long-term use as the mold can be realized. In addition, a thermoplastic resin used for the mold has been widely used conventionally as a main constituent material of plastic lenses and optical elements. Waste materials generated in production stages thereof can be reused as molding die materials, which is advantageous in the economic and environmental aspects. Further, such a thermoplastic resin itself is characteristic of extremely high transparency in the short wavelength range, having, as a molding die, high transparency with respect to irradiation light used for curing, as well as having excellent mold releasing properties with respect to an actinic radiation curable resin constituting an optical element.

Moreover, in the present invention, inorganic fine particles are preferably added to the actinic radiation curable resin. Such inorganic fine particles are added to the actinic radiation curable resin, whereby the durability of the actinic radiation curable resin is enhanced and then deterioration of optical members constituted of the actinic radiation curable resin can be inhibited.

### EFFECTS OF THE INVENTION

According to the present invention, a plastic molding die is used as a molding die, whereby excellent flexibility is expressed compared with the case of use of a glass molding die. Even when a flat glass plate and a molding die are brought into close contact together in the step to press the flat glass plate (refer to above (2)), mold releasing is easily carried out. Further, even when the flat glass plate is arranged in the state of being inclined with respect to the molding die or foreign substances are present therebetween, the flat glass plate and the molding die remain in close contact to each other and then liquid leakage from the molding die prior to molding tends not to occur. Further, the molding die is plastic-made, being whereby lightweight and resistant to breakage due to its material characteristics. And processing/polishing treatment of cavity portions is easily carried out. Therefore, according to the present invention, liquid leakage prior to molding can be inhibited and also mold releasing properties after molding can be enhanced. Further, problems in handling resulting from the molding die itself and in production can be solved.

### BRIEF DESCRIPTION OF THE DRAWINGS

FIG. 1 is a perspective view showing one example of the schematic constitution of an optical device according to the preferred embodiment of the present invention; and

FIG. 2 is a schematic sectional view showing one example of the method for producing an optical device according to the preferred embodiment of the present invention.

### DESCRIPTION OF THE NUMERIC DESIGNATIONS

1: optical device
10: sensor device
20 hybrid optical element grouping
22: flat glass plate
24: lens
30: molding die
32: cavity
40: actinic radiation curable resin
50: light source

### PREFERRED EMBODIMENT OF THE INVENTION

The preferred embodiment of the present invention will now be described with reference to drawings.

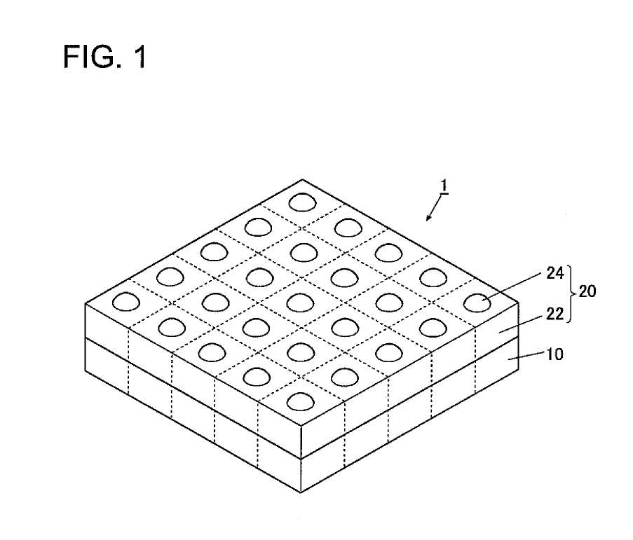

FIG. 1 is a perspective view showing one example of the schematic constitution of an optical device according to the preferred embodiment of the present invention.

As shown in FIG. 1, an optical device 1 according to the preferred embodiment of the present invention is mainly constituted of a sensor device 10 and a hybrid optical element grouping 20. The hybrid optical element grouping 20 has a constitution in which a transparent flat glass plate 22 is provided and thereon a plurality of lenses 24 are placed in a grid arrangement. The lens 24 is one example of the optical members and in the present preferred embodiment, light enters the optical devices 1, and then the light passes through the lenses 24 and the flat glass plate 22 and enters the sensor devices 10. Then, photoelectric conversion is carried out by the sensor devices 10 to form an image. In FIG. 1, the optical devices 1 are integrally drawn. However, in product shipping, each thereof is shipped as a product (an optical device 1) after having been cut and divided in a grid pattern with respect to each lens 24 as shown in dashed lines.

The lens 24 is constituted of a transparent actinic radiation curable resin. An actinic radiation curable resin according to the present invention is one which is cured via irradiation of actinic radiation (especially, infrared radiation, ultraviolet radiation (UV)), or electron beams). As such an actinic radiation curable resin according to the present invention, those forming a transparent resin component via curing are usable with no specific limitation. As the actinic radiation curable resin according to the present invention, for example, an epoxy resin, an acrylic resin, an oxetane resin, a vinyl ester resin, or a silicone resin is favorably used. Of these resins, especially from the viewpoint of small curing contraction, an epoxy resin is preferably used. Typical (1) epoxy resins and polymerization initiators therefor and (2) acrylic resins and polymerization initiators therefor will now be described.

(1) Epoxy Resins

When an epoxy resin is used as an actinic radiation curable resin, any one can be used if having at least 2 epoxy groups in one molecule. As such an epoxy resin, there can be specifically exemplified a bisphenol A-type epoxy resin, a phenol novolac-type epoxy resin, an o-cresol novolac-type epoxy resin, a triphenylmethane-type epoxy resin, a halogenated epoxy resin such as a bromine-containing-type epoxy resin, and an epoxy resin having a naphthalene ring. With regard to an aromatic epoxy resin, a hydrogenation-type epoxy resin may be formed in such a manner that the aromatic ring is subjected to nucleus hydrogenation to form a cyclohexane ring.

In the case of use of an epoxy resin, as a photopolymerization initiator, a cationic photopolymerization initiator and an anionic photopolymerization initiator can be exemplified. Examples of the cationic photopolymerization initiator include a sulfonium salt, an iodonium salt, a diazonium salt, and a ferrocenium salt.

As examples of the sulfonium salt, there are favorably used ADEKA OPTOMER SP-150 and ADEKA OPTOMER SP-170 (produced by Asahi Denim Kogyo Co., Ltd.), SANAID SI-60L, SI-80L, SI-100L, and SI-150L (produced by Sanshin Chemical Industry Co., Ltd.), CYRACURE UVI-6074, UVI-6990, UVI-6976, and UVI-6992 (produced by Dow Chemicals Co.), and UVACURE 1590 (produced by Daicel UCB Co., Ltd.), all of which are available on the market.

As examples of the iodonium salt, there are favorably used UV9380 (produced by GE Toshiba Silicones Co., Ltd.) and IRUGACURE 250 (produced by Ciba Specialty Chemicals Inc.).

The added amount of a photopolymerization initiator for an epoxy resin is 1-10 parts as an initiator based on 100 parts of the epoxy resin, preferably 4 parts. Herein, a curing accelerator may be added if appropriate.

(2) Acrylic Based Resin

Actinic energy radiation curable resin having an adamantane skeleton is preferably used as acrylic based resin. Specific example of actinic energy radiation curable resin having an adamantane skeleton include: 2-alkyl-2-adamantyl (meth)acrylate (JP-A No. 2002-193883), 3,3′-dialkoxycarbonyl-1,1′-biadamantane (JP-A No. 2001-253835), 1,1′-biadamantane compound (U.S. Pat. No. 3,342,880), tetraadamantane (JP-A No. 2006-169177), actinic energy radiation curable resin having adamantine skeleton without having aromatic ring such as 2-alkyl-2-hydroxy adamantine, 2-alkylene adamanatane, 1,3-adamantane dicarbonic acid di-ter-butyl (JP-A No. 2001-322950), bis(hydroxyphenyl) adamantanes or bis(glycigyloxyphenyl)adamantine (JP-A Nos. 11-35522, 10-130371).

Various types of initiators are available as a photopolymerization initiator. It is pointed out that as characteristics of a thick layer material, light is hard to penetrate the interior thereof due to absorption of an initiator itself. Therefore, in the preferred embodiment of the present invention, as a photopolymerization initiator when an acrylic resin is used, a highly efficient initiator having broad absorption properties and a relatively small absorption band or absorption edge is preferably used. As the photopolymerization initiator, for example, listed are α-aminoacetophenone, α-hydroxyacetophenone, acylphosphine oxide, and sensitizers.

With regard to α-aminoacetophenone, those having long wavelength absorption (maximum absorption wavelength: at least 325 nm) are specifically desirable. Specific examples thereof include IRGE 369, IRGACURACURE 379, and IRGACURE 907 (produced by Ciba Specialty Chemicals Inc.). Further, as α-hydroxyacetophenone, IRGACURE 127 (produced by Ciba Specialty Chemicals Inc.) is cited.

The added amount of such a photopolymerization initiator is 0.01-10% by mass based on an acrylic resin, preferably 0.1-8.0% by mass, more preferably 0.5-5.0% by mass.

Herein, to enhance the effect of inhibition of linear expansion of the actinic radiation curable resin, it is preferable that inorganic fine particles are added in an actinic radiation curable resin to allow the constituent material of a lens 24 to become a nano-composite material (an organic-inorganic complex material).

As inorganic particles, optical transparent (having light transparency) fine particles are employable, for example fine particles of oxides, sulfides, selenides and tellurides. In concrete, examples of the fine panicles include: silicon oxide, aluminum oxide, aluminum phosphate, titanium oxide, zinc oxide, and zinc sulfate, but is not limited thereto. Preferably used are fine particles of silicon oxide (silica) and calcium carbonate.

One kind of inorganic particles may be used or in combination of a plurality of inorganic particles for these fine particles.

Mixing ratio of inorganic particles based on actinic energy radiation curable resin (volume ratio of inorganic particles in organic-inorganic composite material) is 1 to 50% by volume, preferably 10 to 40% by volume, more preferably 20 to 30% by volume.

The shape of the inorganic particle may be any one of spherical, spheroidal, planar or rod, and especially a spherical particle can fulfill a function effectively. The distribution of the particles is also not limited but ones having relatively narrow distribution are preferable than ones having relatively wide distribution in view of enhancing the effects of the lens 24.

Any known methods can be applied for producing the inorganic particles without any limitation. For example, pyrolysis of metal salt and hydrolysis of metal salt or metal alkoxide is well-known. In a pyrolysis of metal salt, desired inorganic particles can be produced by spraying and pyrolyzing metal salt or solution thereof. In hydrolysis of metal salt or metal alkoxide, desired inorganic particles can be produced by preliminary preparing solution of metal salt or metal alkoxide, following by adding water into the solution and hydrolyzing polymerization.

The average size of the inorganic particles is preferably from 1 nm to 30 nm, more preferably 1 nm to 20 nm, and further preferably from 1 nm to 10 nm. When the average diameter is less than 1 nm, there is the possibility that the desired property cannot be obtained because the particles are difficultly dispersed. When the average diameter exceeds 30 nm, there is the possibility that the light transparency becomes less than 70% by the lowering in the transparency due to the turbid of the organic-inorganic composite material. The average particle diameter in the present invention is the value in the terms of the diameter of the sphere having the same volume. The average particle diameter is the arithmetic mean of the diameters of 100 or more inorganic particles random sampling from photos by an electron microscope.

The inorganic particles relating to the present invention is preferably subjected to the surface treatment. A method for a surface treatment is not particularly limited and any method known can be usable.

Examples of the surface treatment agent to be used for the surface treatment include tetramethoxy silane, tetraethoxy silane, tetraisopropoxy silane, tetrephenoxy silane, methyltrimethoxy silane, ethyltrimethoxy silane, propyltrimethoxysilane, methyltriethoxy silane, methyltriphenoxy silane, ethyltriethoxy silane, phenyltrimethoxy silane, 3-methylphenyltrimethoxy silane, dimethyldimethoxy silae, diethyldiethoxy silane, diphenyldimethoxy silane, diphenyldiphenoxy silane, trimethylmethoxy silane, triethylethoxy silane, triphenylmethoxy silane, triphenylphenoxy silane, cyclopentyltrimethoxy silane, cyclohexyltriethoxy silane, benzyldimethylethoxy silane, octyltiethoxy silane, vinyltriacetoxy silane, vinyltrichloro silane, vinyltriethoxy silane, γ-chloropropyltimethoxy silane, γ-chloropropylmethyldichloro silane, γ-chloropropylmethyldimethoxy silane, γ-chloropropylethyldiethoxy silane, γ-aminopropyltriethoxy silane, N-(β-aminoethyl)-γaminopropyltrimethoxy silane, N-(β-aminoethyl)-γ-aminopropylmethyldimethoxy silane, γ-mercaptopropyltrimethoxysilane, γ-mercaptopropylmethyldimethoxy silane, γ-glycidoxypropyltrimethoxy silane, γ-glycidoxypropylmethyldimethoxy silane, γ-methacryloxypropyltrimethoxy silane, γ-methacryloxypropylmethyldimethoxy silane, γ-(2-aminoethyl)aminopropyltrimethoxy silane, γ-isocyanatepropyltriethoxy silane, γ-(2-aminoethyl)aminopropylmethyldimethoxy silane, γ-anilinopropyltrimethoxy silane, vinyltrimethoxy silane, N-β-(N-vinylbenzilaminoethyl)-γ-aminopropyltrimethoxy silane hydrochloride salt, and an amino silane composition. Further, aluminum, titanium, zirconia can be employed in place of silane. In this case, examples thereof include aluminumtriethoxide and aluminumtriisoproxide.

Also usable are fatty acids such as an isostearic acid, a stearic acid, a cyclopropanecarboxylic acid, a cyclohexanecarboxylic acid, a cyclopentanecarboxylic acid, a cyclohexanepropionic acid, an octylic acid, a palmitic acid, a behenic acid, an undecylenic acid, an oleic acid, a hexahydrophthalic acid, and metal salt thereof, and further, any of organic phosphoric acid based surface treatment agents. These can be used singly, or used by mixing at least two kinds.

These compounds exhibit different characteristics such as a reaction rate and so forth, and those adapted to the conditions of surface treatment can be utilized. These may also be used singly, or in combination of a plurality of kinds. Since the resulting surface-treated particles tend to exhibit different properties depending on the utilized compound, it is also possible to be designed to have affinity with utilized actinic energy radiation curable resin for organic-inorganic composite material in order to obtain a material composition by selecting the utilized compound during surface treatment. The ratio of surface treatment is not particularly limited, but the surface treatment agent preferably has a content of 10-99% by weight, with respect to the weight of particles after surface treatment, and more preferably has a content of 30-98% by weight.

In the case of using an organic-inorganic composite material as a component material of lens 24 in which inorganic particles are added to an actinic energy radiation curable resin instead of above actinic energy radiation curable resin, it is prepared (provided) by a manufacturing method below. There are manufacturing methods in which an organic-inorganic composite material is provided by adding inorganic particles into a melted actinic energy radiation curable resin followed by kneading, or a method in which inorganic particles are mixed with an actinic energy radiation curable resin solved by a solvent and then the solvent is removed from the dispersion.

Among these, a melt-kneading method is preferred as the embodiment of the present invention. A method in which an actinic energy radiation curable resin is polymerized in the presence of inorganic particles, or a method in which inorganic particles are formed in the presence of the actinic energy radiation curable resin are applicable, but special condition is necessary in a preparation of polymerization of actinic energy radiation curable resin or inorganic particles. In the melt-kneading method, organic-inorganic composite material can be manufactured by separately providing an actinic energy radiation curable resin and inorganic particles by known method and then mixing. Therefore organic-inorganic composite material can be manufactured in low cost.

In the melt-kneading method, kneading in the presence of organic solvent is also applicable. When using organic solvent, temperature during melt-kneading can be lowered and result in suppressing deterioration of actinic energy radiation curable resin during kneading process. In this case, after melt-kneading process, organic solvent is preferably removed from the organic-inorganic composite material by reduced pressure.

As devices usable in melt-kneading, there are mentioned a sealed type kneading device such as Laboplasto Mill, a Brabender, a Banbury mixer, a kneader or a roll; and a batch type kneading device. Also, sequential melt-kneading devices such as a single-axis extruder and a double-axis extruder can be used for manufacture.

Mixing device usable to mixing treated inorganic particles and actinic energy radiation curable resin include, for example: KRC kneader (produced by KURIMOTO, Ltd.), Poly Labo system (produced by HAAKE), Nanokon mixer (produced by Toyo Seiki Seisaku-sho, Ltd.), Nauter Mixer Bussco Kneader (produced by produced by Buss Corp.), TEM Extruder (produced by Toshiba Machine co. Ltd.), TEX double-axis kneader (produced by The Japan Steel Works, Ltd.), PCM kneader (produced by Ikegai Tekkousho), three-roll mill, mixing roll mill, kneader (produced by INOUE MFG. INC.), Kneadex (produced by Mitsui Mining co.), MS pressured kneader, Nidaruder (produced by Moriyama seisakusho) and Banbury mixer (produced by Kobe Steel, Ltd.).

In the manufacturing method of the organic-inorganic composite material, the actinic energy radiation curable resin and the inorganic particles can be mixed at once and kneaded or can be mixed step-by-step in installments and kneaded. In the latter case, in the melt-kneading devices such as the extruders, a component to be mixed step-by-step can be added from a middle of the cylinder.

When an organic-inorganic composite material is manufactured by a melt-kneading method, the inorganic particles can be added in the form of powder or aggregates. Alternatively, they can be added in the form of dispersion dispersed in liquid, and when added in the form of dispersion dispersed in liquid, degassing is preferably carried out after kneading.

When the inorganic particles are added in the form of dispersion dispersed in liquid, it is preferred that they are added after aggregated particles are dispersed into primary particles. For the dispersion, while various dispersion devices can be used, a bead mill is particularly preferred. The bead is made of various kinds of materials and its size is preferably smaller. The bead size is preferably from 0.001 to 0.1 mm.

Inorganic particles are preferably added in the form of surface treated state. Also integral blend method in which surface treatment agent and inorganic particles are added simultaneously and complexed with actinic energy radiation curable resin can be usable.

Next, a flat glass plate used in production of a hybrid optical element grouping according to the present invention will now be described.

As a flat glass plate applied to a hybrid optical element grouping according to the present invention, those having the following characteristics are preferable: namely, (1) members applied to an optical system and those through which visible light passes; (2) those through which actinic radiation applied during curing effectively passes since an actinic radiation curable resin is used, and those through which ultraviolet radiation passes especially when an ultraviolet curing resin is used; and (3) a glass material having the same linear expansion coefficient as silicone is desirable since bonding to a sensor (a CCD sensor or a CMOS sensor formed on a silicone substrate) is carried out.

Specifically, in view of the characteristics according to item (2), as a flat glass plate material, the following is cited:

(a) water slide glass: having optical absorption properties in a wavelength range of at most 360 nm and an optical absorptance of 1.7% with respect to a wavelength of 300 nm at a thickness of 1 mm, and herein the wavelength is practically usable to 330 mm;

(b) white slide glass: having optical absorption properties in a wavelength range of at most 330 nm and an optical absorptance of 0.5% with respect to a wavelength of 300 nm at a thickness of 1 mm, and herein the wavelength is practically usable to 300 mm; and

(c) UV radiation transparent products of silica glass: having no optical absorption properties at a wavelength of 240 nm and no optical absorption properties in the entire wavelength range of 200-2000 nm, herein the wavelength is practically usable to 200 nm.

Especially, from the viewpoint of UV radiation transmittance, the white slide glass of above (b) and the UV radiation transparent products of silica glass of above (c) are preferable.

Further, from the viewpoint of the linear expansion characteristics according to item (3), in the respect that linear expansion coefficient is nearly equal to that of a semiconductor silicone substrate (2.4 ppm), PYREX (a registered trademark) (linear expansion coefficient: 3.2 ppm, produced by Corning Inc.) and silica glass (linear expansion coefficient: 0.5 ppm) are preferable.

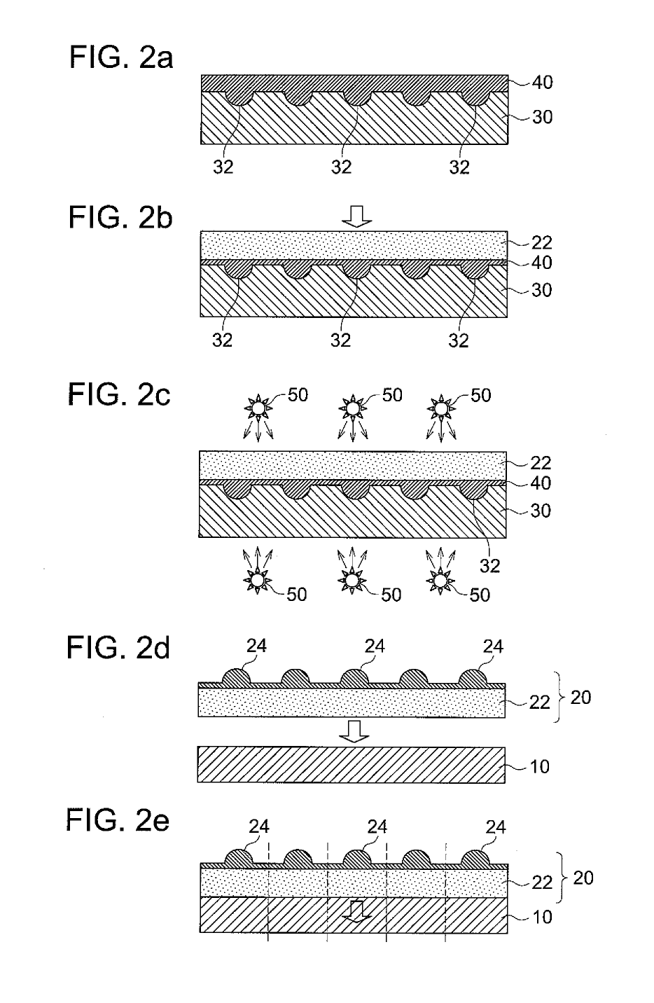

Next, a method for producing an optical device 1 according to the present preferred embodiment (including a method for producing a hybrid optical element grouping 20) will, be described with reference to FIG. 2.

As shown in FIG. 2a, a transparent plastic molding die 30 serving as a molding die is prepared and then an actinic radiation curable resin 40 is poured therein to fill a plurality of provided cavities 32 with the actinic radiation curable resin 40. The molding die 30 has a shape in which the cavities 32 each correspond to lenses 24. In the present invention, the molding die is characterized by being plastic-made. Further, the molding die is preferably constituted of a thermoplastic resin as described later.

In the method for producing a plastic molding die 30 according to the present invention having a concave-type dimple structure as shown in FIG. 2a, as a first step, using a metallic mold block, a metallic blank mold having a plurality of precise convex-type hemispherical structure is produced. Thereafter, a thermoplastic resin, a thermally curable resin, or an actinic radiation curable resin is poured onto this metallic blank mold to produce a plastic transparent molding die 30 having a concave-type dimple structure as shown in FIG. 2a.

As a typical example, a thermoplastic resin favorably used in formation of the molding die 30 will now be detailed.

The thermoplastic resin constituting the molding die 30 includes a transparent resin such as an alicyclic hydrocarbon-based resin, an acrylic resin, a polycarbonate resin, a polyester resin, a polyether resin, a polyamide resin, or a polyimide resin. Of these, an Acyclic hydrocarbon-based resin is specifically preferably used. As the alicyclic hydrocarbon-based resin, those represented by following Formula (1) are exemplified.

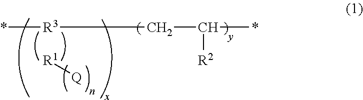

In above Formula (1), x and y each represent a copolymerization rate and an integer satisfying the relationship: 0/100≦y/x≦95/5. And, n represents 0, 1, or 2 and the substitution number of the substituent Q. R¹ represents one or at least 2 types of groups of a valence of (2+n) selected from the group of the hydrocarbon groups of a carbon number of 2-20. R² represents a hydrogen atom or one or at least 2 types of monovalent groups selected from the structure groups of a carbon number of 1-10 containing carbon and hydrogen. R³ represents one or at least 2 types of divalent groups selected from the group of the hydrocarbon groups of a carbon number of 2-20. Q represents one or at least 2 types of monovalent groups selected from the structure groups represented by COOR⁴ (R⁴ represents a hydrogen atom or one or at least 2 types of monovalent groups selected from the structure groups of a carbon number of 1-10 containing hydrocarbon).

In above Formula (1), R¹ is preferably one or at least 2 types of divalent groups selected from the group of the hydrocarbon groups of a carbon number of 2-12, being more preferably represented by following Formula (2) (wherein p represents an integer of 0-2):

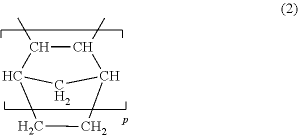

which is a divalent group. A divalent group having p representing 0 or 1 in Formula (2) is more preferable. With regard to the structure of R¹, only one type may be used or at least 2 types may be used in combination. Examples of R² include a hydrogen atom, a methyl group, an ethyl group, an n-propyl group, an i-propyl group, an n-butyl group, and a 2-methypropyl group. A hydrogen atom or a methyl group is more preferable. A hydrogen atom is most preferable. With regard to examples of R³, as preferable examples of the structure units containing this group, when n=0, for example, following Formulas (a), (b), and (c) (herein, in Formulas (a)-(c), R1 is as described above):

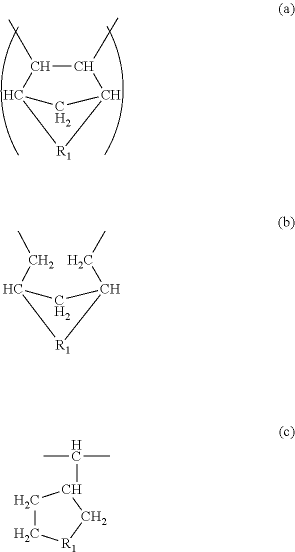

are cited. Further, n preferably represents 0.

In the present embodiment, the type of copolymerization is not specifically limited, and therefore well-known copolymerization types such as random copolymerization, block copolymerization, or alternating copolymerization are applicable. Of these, random copolymerization is preferable.

Further, a polymer used in the present embodiment may have a repeating structure unit derived from another copolymerizable monomer if appropriate, as long as no physical properties of a product obtained by the molding method of the present embodiment are impaired. Its copolymerization rate is not specifically limited but is preferably at most 20 mol %, more preferably at most 10 mol %. When copolymerization is performed further, optical characteristics may be impaired and also a highly precise molding die may not be obtained. In this case, the type of copolymerization is not specifically limited, but random copolymerization is preferable.

As another example of a preferable thermoplastic alicyclic hydrocarbon-based polymer applied to the molding die 30, a polymer is exemplified in which a repeating unit having an alicyclic structure contains a repeating unit (a) having an alicyclic structure represented by following Formula (5) and a repeating unit (b) of a chain structure represented by following Formula (6), Formula (7), or Formula (8) at a total content of at least 90% and further the content of the repeating unit (b) is 1% by mass−less than 10% by mass.

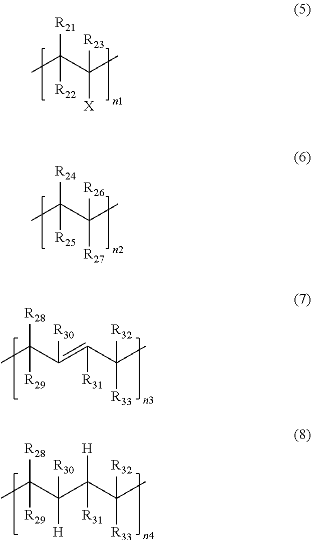

In Formulas (5), (6), (7), and (8), R₂₁-R₃₃ each independently represents a hydrogen atom, a chain hydrocarbon group, a halogen atom, an alkoxy group, a hydroxy group, an ether group, an ester group, a cyano group, an amino group, an imide group, a silyl group, or a chain hydrocarbon group substituted with a polar group (for example, a halogen atom, an alkoxy group, a hydroxy group, an ester group, a cyano group, an amide group, an imide group, or a silyl group). Specifically, as the halogen atom, a fluorine atom, a chlorine atom, a bromine atom, and an iodine atom can be listed. As the chain hydrocarbon group substituted with a polar group, for example, cited is a halogenated alkyl group having a carbon atom number of 1-20, preferably 1-10, more preferably 1-6. As the chain hydrocarbon group, for example, cited are an alkyl group having a carbon atom number of 1-20, preferably 1-10, more preferably 1-6 and an alkenyl group having a carbon atom number of 2-20, preferably 2-10, more preferably 2-6.

X in above Formula (5) represents an alicyclic hydrocarbon group and the number of carbon atoms constituting this group is commonly 4-20, preferably 4-10, more preferably 5-7. When the number of carbon atoms constituting an alicyclic structure is allowed to fall within this range, birefringence can be reduced. Further, the alicyclic structure is not limited to a monocyclic structure and may be a polycyclic structure such as, for example, a norbornane ring.

The alicyclic hydrocarbon group may have a carbon-carbon unsaturated bond. The content thereof is at most 10% of the total carbon-carbon bonds, preferably at most 5%, more preferably at most 3%. When the carbon-carbon bond in the alicyclic hydrocarbon group is allowed to fall within this range, transparency and heat resistance are enhanced. Further, carbon atoms constituting the alicyclic hydrocarbon group may be bonded to a hydrogen atom, a hydrocarbon group, a halogen atom, an alkoxy group, a hydroxy group, an ester group, a cyano group, an amide group, an imide group, a silyl group, or a chain hydrocarbon group substituted with a polar group (a halogen atom, an alkoxy group, a hydroxy group, an ester group, a cyano group, an amide group, an imide group, or a silyl group). Of these, a hydrogen atom and a chain hydrocarbon group having a carbon atom number of 1-6 are preferable in terms of heat resistance and small water absorbability.

Further, above Formula (7) has a carbon-carbon unsaturated bond in the main chain and Formula (8) has a carbon-carbon saturated chain in the main chain. Herein, when transparency and heat resistance are strongly required, the content rate of such an unsaturated bond is commonly at most 10% of the total carbon-carbon bonds constituting the main chain, preferably at most 5%, more preferably at most 3%.

In the present embodiment, in an alicyclic hydrocarbon-based copolymer, the total content of the repeating unit (a) having an alicyclic structure represented by Formula (5) and the repeating unit (b) of a chain structure represented by Formula (6), formula (7), or Formula (8) is, in terms of mass, commonly at least 90%, preferably at least 95%, more preferably at least 97%. When the total content is specified to fall within the range, small birefringence properties, heat resistance, small water absorbability, and mechanical strength are highly balanced.

As the production method for producing the above alicyclic hydrocarbon-based copolymer, a method is cited in which an aromatic vinyl-based compound and another monomer which is copolymerizable are copolymerized together, and then the carbon-carbon unsaturated bonds of the main chain and the aromatic ring are hydrogenated.

The molecular weight of the preferable pre-hydrogenation block copolymer is from 1,000 to 1,000,000, more preferably from 5,000 to 500,000, and particularly preferably from 10,000 to 300,000 in terms of Mw of polystyrene (or polyisoprene) measured by GPC. The mechanical strength is lowered when the Mw of block copolymer is too low, and the hydrogen adding reaction rate is lowered when the Mw is too high.

As the specific example of the aromatic vinyl compound used in the above method, styrene, α-methylstyrene, α-ethylstyrene, α-propylstyrene, α-isopropylstyrene, α-t-butylstyrene, 2-methylstyrene, 3-methylstyrene, 4-methylstyrene, 2,4-diisopropylstyrene, 2,4-dimethylstyrene, 4-t-butylstyrene, 5-t-butyl-2-methylstyrene, monochlrostyrene, dichlorostyrene, monofluorostyrene, and 4-phenylstyrene are cited. Among them, styrene, 2-methylstyrene, 3-methylstyrene and 4-methylstyrene are preferable. These aromatic vinyl compounds can be used individually or in combinations of at least 2 types.

Such another monomer which is copolymerizable is not specifically limited but a chain vinyl compound or a chain conjugated diene compound is used. When such a chain conjugated diene is used, handling in the production process is improved and the strength properties of an obtained alicyclic hydrocarbon-based copolymer are increased.

Specific examples of the chain vinyl compound include, for example, a chain olefin monomer such as ethylene, propylene, 1-butene, 1-pentene, or 4-methyl-1-pentene; a nitrile-based monomer such as 1-cyanoethylene(acrylonitrile), 1-cyano-1-methylethylene (methacrylonitrile), or 1-cyano-1-chlomethylene(α-chloroacrylonitrile); a (meth)acrylic acid ester-based monomer such as 1-(methoxycarbonyl)-1-methylethylene (methacrylic acid methyl ester), 1-(ethoxycarbonyl)-1-methylethylene (methacrylic acid ethyl ester), 1-(propoxycarbonyl)-1-methylethylene (methacrylic acid propyl ester), 1-(butoxycarbonyl)-1-methylethylene (methacrylic acid butyl ester), 1-methoxycarbonylethylene (acrylic acid methyl ester), 1-ethoxycarbonylethylene (acrylic acid ethyl ester), 1-propoxycarbonylethylene (acrylic acid propyl ester), or 1-butoxycarbonylethylene (acrylic acid butyl ester); and an unsaturated fatty acid-based monomer such as 1-carboxyethylene (acrylic acid), 1-carboxy-1-methylethylene (methacrylic acid), or maleic anhydride. Of these, a chain olefin monomer is preferable, and ethylene, propylene, and 1-butene are specifically preferable.

The chain conjugated diem includes, for example, 1,3-butadiene, isoprene, 2,3-dimethyl-1,3-butadiene, 1,3-pentadiene, and 1,3-hexadiene. Of these chain vinyl compounds and chain conjugated dienes, the chain conjugated dienes are preferable, and butadiene and isoprene are specifically preferable. These chain vinyl compounds and chain conjugated dienes can be used individually or in combination of at least two types.

Polymerization reaction is not specifically limited to radical polymerization, anionic polymerization, and cationic polymerization, but anionic polymerization is preferable in view of polymerization operations, ease of hydrogenation reaction in a post process, and mechanical strength of a finally-obtained hydrocarbon-based copolymer.

In the case of anionic polymerization, a method such as block polymerization, solution polymerization, or shiny polymerization can be employed in the presence of a polymerization initiator, commonly in a temperature range of 0-200° C., preferably 20-100° C., specifically preferably 20-80° C. However, in view of elimination of reaction heat, solution polymerization is preferable. In this case, an inert solvent capable of dissolving a polymer and a hydrogenated product thereof is used. Examples of the inert solvent used in such solution reaction include an aliphatic hydrocarbon such as n-butane, n-pentane, iso-pentane, n-hexane, n-heptane, or iso-octane; an alicyclic hydrocarbon such as cyclopentane, cyclohexane, methylcyclopentane, methylcyclohexane, or decalin; and an aromatic hydrocarbon such as benzene or toluene. As a polymerization initiator for the above anionic polymerization, usable are, for example, a mono-organolithium compound such as n-butyl lithium, sec-butyl lithium, t-butyl lithium, hexyl lithium, or phenyl lithium; and a polyfunctional organolithium compound such as dilithiomethane, 1,4-diobutane, or 1,4-dilithio-2-ethylcyclohexane.

When hydrogenation reaction of carbon-carbon double bonds in an unsaturated ring such as an aromatic ring and a cycloalkene ring or of unsaturated bonds in the main chain in a copolymer before hydrogenation is carried out, the reaction method and reaction form are not specifically limited, and can be performed based on a well-known method. However, preferable is a hydrogenation method which can increase the hydrogenation rate and also can decrease polymer chain cleavage reaction induced simultaneously with the hydrogenation reaction. A method employing a catalyst containing at least one metal selected from nickel, cobalt, iron, titanium, rhodium, palladium, platinum, ruthenium, and rhenium in an organic solvent is exemplified. The hydrogenation reaction is usually carried out at a temperature of from 10 to 250° C., and a temperature of from 50 to 200° C. is preferable and that from 80 to 180° C. is more preferable for raising the hydrogenation ratio and inhibiting the polymer cleaving reaction. The pressure of hydrogen is preferably from 0.1 to 30 MPa and more preferably from 1 to 20 MPa and particularly preferably from 2 to 10 MPa from the viewpoint of the above and the operation suitability.

The hydrogenation ratio of thus obtained hydrogenated product at the carbon-carbon unsaturated bond of the main chain and the side chain and the carbon-carbon unsaturated bond of the aromatic ring or cycloalkene ring is preferably not less than 90%, more preferably not less than 95%, and particularly preferably not less than 97% in the value measured by H′ NMR. When the hydrogenation ratio is low, the birefringence properties and thermal stability of the copolymer are lowered.

A method for recovering the hydrogenated product after the hydrogenation reaction is not specifically limited. Generally employed is a method in which the hydrogenation catalyst is removed from the reaction liquid by filtration or centrifugation and the solvent is directly removed by evaporation or a method in which the reaction liquid is poured into a poor solvent of the hydrogenated product to coagulate the hydrogenated product.

Subsequently, as shown in FIG. 2b, the fiat glass plate 22 is arranged from the side where the actinic radiation curable resin 40 has been filled in the molding die 30 so as to apply a pressure to the resin, whereby the actinic radiation curable resin 40 is sealed in the cavities 32. In this state, as shown in FIG. 2c, the light source 50 is lit and then actinic radiation such as, for example, ultraviolet radiation is irradiated to the actinic radiation curable resin 40 from both sides, namely from above the flat glass plate 22 and from below the molding die 30 exhibiting actinic radiation transparency. Herein, both the flat glass plate 22 and the molding die 30 are transparent. Therefore, employable is a method in which radiation irradiation may be carried out from either direction.

As the light source 50, a lamp such as a H-Lamp (a high pressure mercury lamp), a G-Lamp, or a F-Lamp can be used. Of these, from the viewpoint of emission stability, as the light source 50, a high pressure mercury lamp with a peak at a wavelength of 365 nm is preferably used. To uniform the light intensity of the light source 50, a filter such as a diffuser plate may be allowed to be present between the light source 50 and the flat glass plate 22 as well as the molding die 30, if appropriate.

Light having entered from above the molding die 30 passes through the flat glass plate 22 and reaches the actinic radiation curable resin 40. In contrast, light having entered from below the molding die 30 passes through the molding die 30 and reaches the actinic radiation curable resin 40. Especially, the transmittance of the thinnest portion (the portion where the cavity 32 is formed) of the molding die 30 is set to be extremely large, which is at least 90%, with respect to light of the light source 50, whereby the light adequately penetrates the interior of the actinic radiation curable resin 40 in the cavity 32. With the above radiation irradiation, the actinic radiation curable resin 40 is cured and then a lens 24 is formed.

As the transmittance referred to in the present invention, employed is a value obtained as average transmittance at a wavelength of 300-380 nm, using Hitachi spectrophotometer U-4100 (produced by Hitachi, Ltd.).

Thereafter, the flat glass plate 22 in which the lens 24 has been formed is released from the molding die 30 and then a hybrid optical element grouping 20 is produced. In this case, a plurality of lenses 24 are basically formed on the flat glass plate 22. To enhance adhesion properties between the lenses 24 (the actinic radiation curable resin 40) and the flat glass plate 22, the flat glass plate 22 may previously be treated with a silane coupling agent.

As a silane coupling agent for an epoxy resin, a coupling agent having an epoxy group in the molecule is usable. For example, KBM-303, KBM-403, KBE-402, and KBE-404 (produced by Shin-Etsu Silicone) can be used.

As a silane coupling agent for an acrylic resin, a coupling agent having a vinyl group in the molecule is usable. For example, KBM-1003 and KBE-1003 (produced by Shin-Etsu Silicone) can be used. Further, as a silane coupling agent for an acrylic resin, a silane coupling agent such as one having a methacryloxy group in the molecule is also usable. For example, KBM-502, KBM-503, KBE-502, and KBE-503 (produced by Shin-Etsu Silicone) can be used.

Thereafter, as shown in FIGS. 2d and 2e, the hybrid optical element grouping 20 is mounted on sensor devices 10, which are then cut and divided simultaneously with respect to each lens 24 to produce a plurality of optical devices 1. When only a hybrid optical element grouping 20 is simply produced, no mounting onto the sensor devices 10 is carried out and each lens 24 needs only to be cut and divided. Herein, in the present embodiment, disclosed is an embodiment in which lenses 24 are provided only on one side of the flat glass plate 22. However, such lenses 24 may be provided on both sides of the flat glass plate 22. In this case, based on the processing of each step in FIG. 2a-FIG. 2c, lenses 24 are formed and the flat glass plate 22 is released from the molding die 30. Thereafter, the flat glass plate 22 is turned over and then the processing of each step in FIGS. 2a-2c needs only to be conducted again.

According to the above present embodiment, as the molding die 30, a molding die made of a thermoplastic resin is used. Thereby, compared with the case of use of a glass molding die, excellent flexibility is expressed; in the step (refer to FIG. 2b) in which a flat glass plate 22 is pressed against the molding die 30, mold releasing is easily carried out even when the flat glass plate 22 and the molding die 30 are in close contact together; and even when the flat glass plate 22 is arranged in the state of being inclined with respect to the molding die 30 and foreign substances are present therebetween, the flat glass plate 22 and the molding die 30 remain in close contact, whereby prior to molding, liquid leakage of an actinic radiation curable resin 40 from the molding die 30 tends not to occur.

Further, the molding die 30 is made of a thermoplastic resin, which thereby, due to its material, makes it possible for the molding die to be lightweight and to be hard to break and also makes it possible for a cavity 32 to be easily processed and polished. Thereby, according to the present embodiment, liquid leakage of an actinic radiation curable resin 40 prior to molding can be inhibited and also mold releasing properties after molding can be enhanced. Further, the handling or production problem resulting from the molding die 30 itself can be solved.

Still further, the molding die 30 is made of a thermoplastic resin, whereby if a master mold is produced, the mold can continue to be used over a long-term period as such. Thereby, the molding die 30 can easily be mass-produced. In such mass production, the molding die 30 is more inexpensive, in production cost, than a glass-made one and basically exhibits excellent flexibility, whereby no tendency to be damaged or broken is shown, resulting in realization of long-term use. Further, the constituent material of the molding die 30 is allowed to be a thermoplastic resin, whereby any resin remaining as the residue during molding of a common pick-up lens (a remaining resin having been filled and cured in the runner section or the sprue section) can be reused via melting. Still further, in general, part of such a thermoplastic resin remaining as the residue is colored in some cases depending on the intended purpose for a pick-up lens to be used, resulting in limitation in reuse as an optical element or a plastic lens. Even such a colored residual resin can adequately be reused if satisfying, as a molding die, transparency conditions of actinic radiation, whereby wasted materials can effectively be reused, which can be referred to as an environmentally-sound method.

Still more, only part of the hybrid optical element grouping 20 is constituted of an actinic radiation curable resin 40, whereby the used amount of such a resin is smaller than in the case in which the constitution is entirely made with the resin and also the used amount of an expensive resin is reduced, resulting in reduced cost.

Yet further, in general, compared with glass, a resin exhibits large curing contraction during molding, resulting in a large effect on optical characteristics. However, in the hybrid optical element grouping 20, a part thereof is made of a resin and the used mount of the resin is small, whereby small curing contraction during molding is expressed and the effect on optical characteristics can be prevented. Similarly, in general, compared with glass, a resin exhibits large shape variation (linear expansion) during temperature changes and large shape variation during water absorption. However, in the hybrid optical element grouping 20, a part thereof is made of a resin and the used mount of the resin is small, whereby shape variation during temperature changes and shape variation during water absorption can be prevented.

Furthermore, similarly to the method for producing the hybrid optical element grouping 20 of the present embodiment, when a casting production method realizing melt fluidity is used, no molding apparatus is required and also the coat of equipment investment can be reduced.

### Examples

The present invention will now specifically be described with reference to examples that by no means limit the scope of the present invention. Herein, the designation of “parts” or “%” referred to in the examples represents “parts by mass” or “% by mass,” unless otherwise specified.

<<Production of Molding Dies>>

[Production of Molding Die 1]

Blockish silica glass was subjected to cutting processing to produce a glass molding die having the same structure as the molding die (30) shown in FIG. 2. The thus-produced molding die was designated as a molding die 1.

[Production of Molding Die 2]

Initially, a metallic blank mold was produced. As the base material for the blank mold, an iron based metal was used and then the molding transfer side was subjected to electroless nickel plating treatment. Subsequently, the blank mold having been subjected to such electroless nickel plating treatment was ground with a diamond tool to produce a metallic blank mold having the configuration of 32 and 40 of FIG. 2.

Thereafter, the thus-produced blank mold was subjected to melt ejection of a thermoplastic resin 1 (APL5014DP being an acyclic hydrocarbon-based copolymer, produced by Mitsui Chemicals, Inc.) to produce a molding die 2 made of a thermoplastic resin.

[Production of Molding Die 3]

The blank mold having been used in production of the molding die 2 was subjected to melt ejection of a thermoplastic resin 2 (ACRYPET MF being polymethyl methacrylate, produced by Mitsubishi Rayon Co., Ltd.) to produce a molding die 3 made of a thermoplastic resin.

[Production of Molding Die 4]

Based on the method described in Unexamined Japanese Patent Application Publication No. 2002-193883, 2-alkyl-2-adamantyl (meth)acrylate being a curable resin was prepared and then azobisisobutyronitrile (AIBN) was added, as a thermopolymerization initiator, to this curable resin at 1.5% by mass to prepare a curable resin composition. Then, the blank mold having been used in production of the molding die 2 was subjected to melt ejection of the above curable resin composition to produce a molding die 4 made of a curable resin.

[Production of Hybrid Optical Elements]

(Production of Hybrid Optical Element 1)

Based on the production flow of a hybrid optical element shown in FIG. 2, a hybrid optical element 1 was produced.

1) As shown in FIG. 2a, a specific amount of the following actinic radiation curable resin monomer solution 1 was filled in the above-produced molding die 1 (silica glass-made).

<Preparation of Actinic Radiation Curable Resin Monomer Solution 1>

UVI-6992 (produced by Dow Chemicals Co.) was added, as a cationic polymerization initiator, to CELLOXIDE 2021P being an epoxy resin monomer (produced by Dicel Chemical Industries, Ltd.) at 1.0% by mass to prepare an actinic radiation curable resin monomer solution 1.

2) Then, as shown in FIG. 2b, a flat glass plate was placed on the actinic radiation curable resin monomer solution 1.

3) Then, as shown in FIG. 2c, as a pressure of 13.4 kPa was applied from above the flat glass plate, from both sides being the flat glass plate side and the molding die side, ultraviolet irradiation was carried out at a condition of 6 J/cm² using a high pressure mercury lamp as a light source for curing to cure the actinic radiation curable resin for formation of a lens 24.

4) As shown in FIG. 2d, the thus-cured actinic radiation curable resin and the flat glass plate were separated from the molding die to produce a hybrid optical element 1.

(Production of Hybrid Optical Elements 2-4)

Hybrid optical elements 2-4 were produced in the same manner as in production of the above hybrid optical element 1 except that instead of the molding die 1, the molding dies 2, 3, and 4 were used respectively.

(Production of Hybrid Optical Element 5)

A hybrid optical element 5 was produced in the same manner as in production of the above hybrid optical element 2 except that instead of the actinic radiation curable resin monomer solution 1, an actinic radiation curable resin monomer solution 2 prepared based on the following method was used.

<Preparation of Actinic Radiation Curable Resin Monomer Solution 2>

UVI-6992 (produced by Dow Chemicals Co.) serving as a cationic polymerization initiator and silica fine particles RX300 (average particle diameter: 7 nm) (produced by Nihon Aerosil Co., Ltd.) serving as inorganic fine particles were added to CELLOXIDE 2021P being an epoxy resin monomer (produced by Dicel Chemical Industries, Ltd.) at 1.0% by mass and 20% by mass, respectively, followed by dispersion treatment to prepare an actinic radiation curable resin monomer solution 2.

<<Evaluation of the Molding Dies and the Hybrid Optical Elements (Lenses)>>

Each of the following evaluations was conducted on the above-produced molding dies and hybrid optical elements.

[Evaluation of Durability]

Using each molding die, hybrid optical elements were repeatedly produced a hundred times based on the above method, and then transmittance A immediately after production of each molding die and transmittance B after production of the 100th lens 24 each were determined as average transmittance at a wavelength range of 300-380 nm, using Hitachi spectrophotometer U-4100 (produced by Hitachi, Ltd.). Transmittance variation rate was determined by the following expression and then based on the following criteria, durability evaluation was conducted.

Transmittance variation rate (%)=transmittance B/transmittance A×100

A: Transmittance variation rate is at least 98%.

B: Transmittance variation rate is 95%—less than 98%.

C: Transmittance variation rate is 93%—less than 95%.

D: Transmittance variation rate is less than 93%.

[Evaluation of Mold Releasing Properties]

As shown in FIG. 2c, an actinic radiation curable resin was cured and thereafter the ease in removal thereof from a molding die 30 was observed. Then, mold releasing properties were evaluated based on the following criteria.

A: After curing, a lens made of an actinic radiation curable resin was able to be easily separated from the molding die even by applying no force.

B: After curing, a lens made of an actinic radiation curable resin was able to be separated from the molding die by applying an extremely small force.

C: After curing, a lens made of an actinic radiation curable resin was able to be separated from the molding die by applying a small force.

D: After curing, a lens made of an actinic radiation curable resin was unable to be separated from the molding die without applying a large force.

[Evaluation of Distortion Resistance]

As a pressure of 13.4 kPa was applied, in order to confirm the presence or absence of occurrence of lens distortion with respect to each lens 24 having been produced via UV irradiation, birefringence observation was conducted based on the Senarmont method. The level in which no occurrence of birefringence was noted was judged as A and the level in which occurrence of birefringence was noted was judged as B.

The thus-obtained results are shown in Table 1.

TABLE 1

| | Lens Constitution | | Molding Die | | Each Evaluation Result | | | |
|---|---|---|---|---|---|---|---|---|
| | | Inorganic Fine | Constitution | | | Mold Releasing | Distortion | |
| Lens No. | Resin Material | Particles | No. | Material | Durability | Properties | Resistance | Remarks |
| 1 | epoxy resin | none | 1 | silica glass | B | C | B | comparative |
| 2 | epoxy resin | none | 2 | thermoplastic resin 1 | A | A | A | inventive |
| 3 | epoxy resin | none | 3 | thermoplastic resin 2 | B | B | A | inventive |
| 4 | epoxy resin | none | 4 | thermally curable resin | C | B | A | inventive |
| 5 | epoxy resin | silica particles | 2 | thermoplastic resin 1 | A | A | A | inventive |

The results described in Table 1 clearly show that a molding die specified by the present invention exhibits excellent durability and mold releasing properties and also can produce high grade plastic lenses with no distortion occurrence.

1. A method for producing a hybrid optical element grouping in which a plurality of optical members of an actinic radiation curable resin are arranged on a flat glass plate, comprising steps of:
filling the actinic energy radiation curable resin in a plastic molding die containing a plurality of cavities each having shape corresponding to the optical members,
disposing the flat glass plate thereon,
irradiating light from at least one direction of the molding die side and the flat glass plate side to cure the actinic radiation curable resin having been filled in the molding die.

2. The method for producing the hybrid optical element grouping of claim 1, wherein a transmittance of the radiation light in the thinnest portion of the molding die is 90% or more.

3. The method for producing the hybrid optical element grouping of claim 1, wherein the plastic molding die is constituted of a thermoplastic resin.

4. The method for producing the hybrid optical element grouping of claim 3, wherein the thermoplastic resin is an alicyclic hydrocarbon based resin.

5. The method for producing the hybrid optical element grouping of claim 1, wherein inorganic fine particles are added to the actinic radiation curable resin.
